(19) United States
(12) Patent Application Publication
(10) Pub. No.: US 2013/0089918 A1
(43) Pub. Date: Apr. 11, 2013

(54) Food Waste Digestion System

(71) Applicant: Terrence Atkinson, Pukekohe (NZ)

(72) Inventor: Terrence Atkinson, Pukekohe (NZ)

(73) Assignee: Bio-Cosmo Technologies Limited, Pukekohe (NZ)

(21) Appl. No.: 13/805,636

(22) PCT Filed: Jul. 8, 2011
(86) PCT No.: PCT/IB2011/053038

§ 371 Date: Dec. 19, 2012

(30) Foreign Application Priority Data
Jul. 8, 2010 (NZ) 586690

(51) Int. Cl. C05F 9/02

(52) U.S. Cl. CPC C05F 9/02
USPC 435/267; 435/290.2

(57) ABSTRACT

A waste digestion system including a primary digester and one or more first subsequent digesters for processing non-liquid organic waste material without the addition of external heat using thermophilic aerobic bacteria to produce a stable product, said digesters being configured to contain contents including the waste material, each of said digesters further including mixing means configured to mix the contents of that digester with feed air drawn through the contents during processing in such a way as to maintain essentially aerobic conditions within the digester; such that the waste material is first processed in the primary digester before a proportion of the contents of the primary digester are transferred to at least one first subsequent digester where further processing occurs; if the first subsequent digester completes the processing then it is a final subsequent digester.

### TECHNICAL FIELD

The present invention relates to a waste digestion system and method, more particularly a waste digestion system for food wastes, though other organic waste streams can be processed, using thermophilic aerobic bacteria.

### BACKGROUND ART

Any discussion of the prior art throughout the specification is not an admission that such prior art is widely known or forms part of the common general knowledge in the field.

Food wastes have been traditionally disposed of in a variety of different ways such as being fed directly to livestock and burial in land-fill sites to decompose anaerobically. These methods have there problems, for example feeding unprocessed food waste to livestock can result in diseases entering the food chain. The landfill sites require large areas of land and although some collect the resultant gases (generally considered undesirable due to their being regarded as “greenhouse gases”) many do not.

To overcome some of the problems associated with anaerobic decomposition of food wastes in landfills windrow composting has become common. Windrow composting reduces, but often does not completely eliminate, the anaerobic decomposition of the food waste. Windrow composting has many problems, especially when carried out on large scale. There are numerous techniques employed to overcome these problems, but there are some issues that cannot be fully overcome with windrow composting, such problems include
The relatively large area of land required.
The potential for unpleasant smells, vermin and insect infestation.
The potential nutrient loss as leachate, which may also be seen as a pollutant.
The inability to maintain complete, or sufficient, control of the conditions throughout the entire digest.

With windrow composting the materials processed and/or the use to which the resultant product can be used can be limited by pathogens remaining in the final product. These pathogens can be eliminated by further processing but this adds to the cost and/or processing time.

Windrow processing can take from as little as 4 weeks to complete digestion but typically 3 to 6 months. This long processing time locks up a large area of land for a significant period of time.

A further potential problem with windrow digestion is the potential for excessive moisture to remain in the resulting product. This moisture can be removed by drying or blending with other material but this adds to the cost. If not removed the moisture can pose storage problems, increase the health risks involved with using or handling the product (for example legionella infections have been linked back to moist compost) and increase transportation costs.

There are many in vessel composting techniques that overcome many of the difficulties associated with wind-row composting. But they have difficulty processing high protein materials and are effectively limited to vegetation with at most a small proportion of food waste. These systems though faster still have processing times measured in weeks rather than days.

Vessel based digestion systems often produce wet or moist end-products that can require specialist distribution or spreading resources to return the end product to farms and gardens. Some systems produce a dry product, but they use an external heat source to do so adding to the processing costs.

Some systems mix the material to be processed with paddles or blades rotated within the vessel, this can have a substantial energy cost due to friction between the mixing arm and the contents.

The present invention aims to reduce or eliminate some or all of the deficiencies in the existing methods as highlighted above.

### DISCLOSURE OF INVENTION

The present invention provides a waste digestion system including a primary digester and one or more first subsequent digesters for processing non-liquid organic waste material without the addition of external heat, using thermophilic aerobic bacteria to produce a stable product, said digesters are configured to contain contents including the waste material, said digesters further include mixing means configured to mix the contents of that digester with feed air drawn through contents during processing in such a way as to maintain essentially aerobic conditions within the digester; such that the waste material is first processed in the primary digester before a proportion of the contents of the primary digester are transferred to at least one first subsequent digester where further processing occurs, if the first subsequent digester completes the processing then it is a final subsequent digester.

Preferably following the or each first subsequent digester there is a second subsequent digester configured to further process the contents transferred from an upstream first subsequent digester, where a second subsequent digester completes the processing then it is a final subsequent digester.

In a highly preferred form following the or each second subsequent digester there is one or more serially connected further subsequent digester configured to further process the contents transferred from an upstream subsequent digester, where a second or further subsequent digester completes the processing then it is a final subsequent digester.

Preferably the contents in each of the subsequent digesters is friable.

Preferably the or each final subsequent digester is configured to complete the processing of the waste material. Preferably each final subsequent digester is configured to produce a dry product without any additional drying necessary. Preferably the processing occurs between 60° C. and 70° C.

In a highly preferred form there is a size reduction means between one or more immediately adjacent digesters. Preferably each size reduction means can be independently controlled.

Preferably the waste material is high in protein.

Preferably the thermophilic aerobic bacteria are naturally part of the organic waste material. In a highly preferred form the thermophilic aerobic bacteria are added. In a further preferred form the added thermophilic aerobic bacteria is one or more strains of bacillus subtilis or similar higher temperature naturally occurring bacteria

Preferably each digester is essentially cylindrical, conical or a combination of these shapes with the mixing means including at least one strip attached to an inner surface of said digester, such that the plane of the or each said strip lies perpendicular to the inner surface to which it is attached, wherein the or each strip follows a continuous or discontinuous helical or curved path along at least part of the length of the inner surface.

Preferably the waste digestion system includes a wet scrubber configured to contact an air stream drawn from the digesters with a contact fluid to form a spent scrubber fluid. Preferably the contact fluid is selected from the following list an acidified contact fluid, an alkaline contact fluid, a solvent based contact fluid, a non solvent based contact fluid, a formulated contact fluid and a combined contact fluid, where the formulated contact fluid is configured to extract, dissolve and/or neutralise nitrogen and sulphur compounds from the air drawn from the digesters. Preferably the spent scrubber fluid is a nitrogen-rich fluid. Preferably the spent scrubber fluid is essentially neutral.

Preferably the waste digestion system includes a heat exchanger configured to essentially dry a warm moist air stream extracted from each digester creating a dried air stream and a condensate. Preferably the heat exchanger is configured to separate of a proportion of the dried air and mix it with fresh air to create the cool feed air. Preferably the heat exchanger is configured to recover the heat from the warm moist air and use it to heat the cool feed air prior to returning it to each digester.

In a highly preferred form the condensate is a product of the system. In a preferred form the condensate is further processed to separate out, or form a concentrate rich in, plant growth stimulants.

The present invention also provides a method of using the waste digestion system that includes the following steps:
A. feed waste material and filler material into a primary digester which has an active population of thermophilic aerobic bacteria;
B. agitate and aerate the waste material in the primary digester;
C. add waste material and filler material;
D. when the primary digester is full transfer a proportion of the contents into a first subsequent digester, and continue processing in all digesters;
E. extract warm moist air from the digesters and convey it to a heat exchanger and condense out a liquid product;
F. continue adding material to the first subsequent digester until full;
G. process the contents in the first subsequent digester until completion;
H. discharge the stable product from the first subsequent digester.

The invention further includes an alternative method of using the waste digestion system that includes the following steps:
A. feed waste material and filler material into a primary digester which has an active population of thermophilic aerobic bacteria;
B. agitate and aerate the waste material in the primary digester;
C. add waste material and filler material;
D. when the primary digester is full transfer a proportion of the contents into a first subsequent digester, and continue processing in both digesters;
D1. when the first subsequent digester is full transfer a proportion of the contents into a second subsequent digester, and continue processing in all digesters;
D2. if a further subsequent digester is present then when the second subsequent digester is full transfer a proportion to a further subsequent digester, and continue processing in all digesters;
G1. process the contents in the final subsequent digester until completion;
H1. discharge the stable product from the final subsequent digester.

Preferably at the same time as any one of steps A to H1 are undertaken step E1 is undertaken,
E1. extract warm moist air from the digesters and convey it to a wet scrubber to produce a spent scrubber fluid.

Preferably the stable product is a dry friable material.

Preferably the waste material is processed to the stable product in less than 48 hours. In a highly preferred for the processing occurs in between 24 and 48 hours.

### BRIEF DESCRIPTION OF DRAWINGS

By way of example only, a preferred embodiment of the present invention is described in detail below with reference to the accompanying drawings, in which:

FIG. 1 is a diagrammatic representation of the waste digestion system;

FIG. 2 is a diagrammatic representation of a second embodiment of the waste digestion system;

FIG. 3 is a flowchart of a method using the waste digestion system of the first or second embodiment;

FIG. 4 is a diagrammatic representation of a third embodiment of the waste digestion system;

FIG. 5 is a flowchart of a method using the waste digestion system of the third embodiment.

### BEST MODE FOR CARRYING OUT THE INVENTION

The process involves the microbiological breakdown of a waste stream by thermophilic aerobic bacteria, sometimes called Thermophilic Aerobic Digestion (TAD). The waste stream to be processed can be any organic waste but is normally high in food waste. The system has been found to be particularly successful in processing high protein waste. The pH and moisture content of the material being processed is maintained by standard means (addition of water, pH modifiers) so is not discussed in any detail. The processing is carried out at between 60° C. and 70° C. and a pH between about 8 and 9, though this does depend on the strain of bacteria used, and may well extend outside these ranges.

It should be noted that the objective of the process is to convert potentially offensive organic waste (which can include certain organic polymers such as man made plastics) into a form where the nutrients contained within can be returned to the soil as a fertiliser. The process produces a friable material, and if sufficiently dry it will not support further microbial activity. How dry the product is depends on the end user's needs.

The process eliminates essentially all of the pathogens originally present in the organic waste and produces a stable product. Where the stable product is one where the majority of the incoming organic waste stream has been broken down to a homogeneous matrix of organic matter. The process may leave items such as larger bones to be separated out and broken down for further processing. The process can produce physically dry material but certain applications may dictate a moist or semi moist friable product.

It should be noted that much organic waste from food preparation establishments contains contaminants such as glass and metal objects, for example knives and forks, these can survive the process and be separated out during or after the process is complete.

The system described can be installed into a standard ISO container with suitable ports and services provided giving a compact transportable waste digestion system, or set up as a stand alone permanent/semi permanent installation.

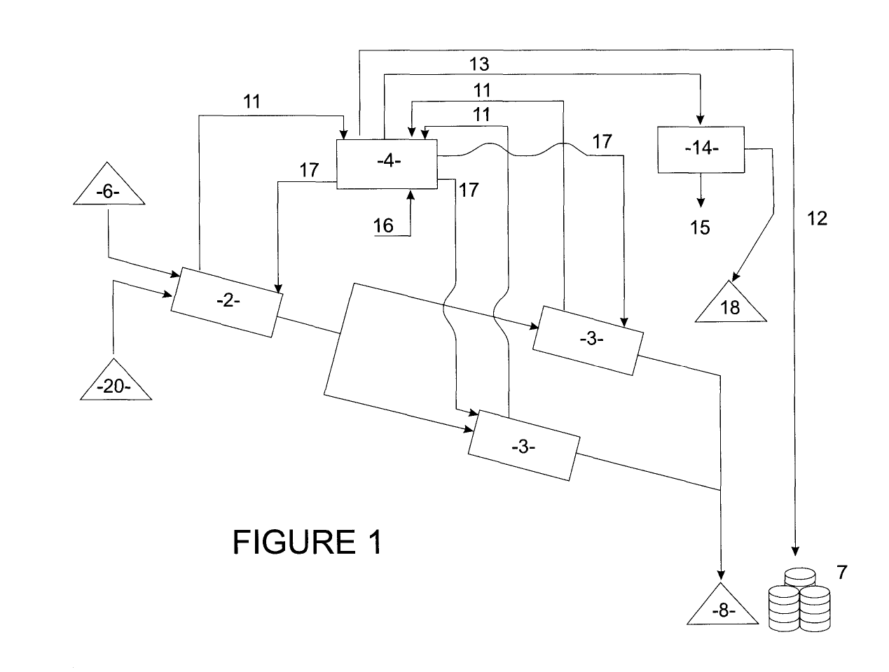

Looking at the system in more detail before the method, and referring to FIG. 1, a waste digestion system (1) including a primary digester (2), a first subsequent digester (3) and a heat exchanger (4) for processing waste material (6) is shown. The digestion of the waste material (6) is commenced in the primary digester (2) and completed in the first subsequent digester (3) and produces at least two product streams, a liquid product (7) stream and a stable product (8) stream.

Each digester (2,3), not shown in detail, is a cylindrical or conically shaped drum which is rotatable along a central axis. In a preferred form each digester (2,3) includes one or more longitudinally aligned helical flights attached to the inside surface of the drum configured to agitate and aerate the contents of said drum when in use. These helical flights may extend part way along, or along the entire, length of the drum and be continuous or discontinuous depending on the material concerned. During operation a slight negative pressure can be maintained in the digesters (2,3) to minimise or eliminate the release of malodorous or harmful gaseous discharges. This slight negative pressure draws the air through the material being processed rather than blowing air through which effectively eliminates potential aerial pollution. Each of the digesters (2,3), when in use, is rotated around its central axis by a known means such as, but not limited to, belt drive system, chain drive system, jockey wheel, direct drive, indirect drive or combination of these.

The heat loss from the digesters (2,3), during processing, is sufficiently low so as to prevent much, if not all, of the moisture present inside said digesters (2,3) from condensing on the inside walls. To minimise the heat loss from the digesters (2,3) may be double skinned or otherwise insulated (by any known means).

During the digestion process warm moist air (11) is produced, this warm moist air (11) from each digester (2,3) is extracted, and passed through the heat exchanger (4) where the moisture is condensed to form a condensate (12) and dried air (13). A portion of the dried air (13) is extracted and flows through a filter (14) to extract the majority if not all the volatile organic compounds not condensed in the heat exchanger (4). The cleaned air (15) is then discharged to atmosphere. To replace the volume of dried air (13) discharged to atmosphere, fresh air (16) is drawn into the heat exchanger (4) and added to the remaining portion of dried air forming the feed air (17) to the digesters (2,3). The feed air (17) is heated prior to being fed into the digesters (2,3). Preferably the heat exchanger (4) cools the incoming warm moist air (11) then, using the heat extracted, heats the feed air (17). The heat exchanger (4) is of, or includes heat exchange components of, a known design, it can be an air to air heat exchanger, a liquid to air heat exchanger in the form of a plate heat exchanger, a shell and tube heat exchanger, cross flow, counter flow or co-flow or similar. The addition of fresh air (16) helps to replenish the oxygen in the feed air (17) consumed by the bacteria.

The filter (14) is at present a carbon filter, but it could be any type of filtration or processing device capable of removing the volatile organic compounds. In one embodiment the volatile organic compounds are burnt. If a carbon filter is used then the spent carbon (18) can be blended with the stable product (8) or fed back into one or more of the digesters (2,3).

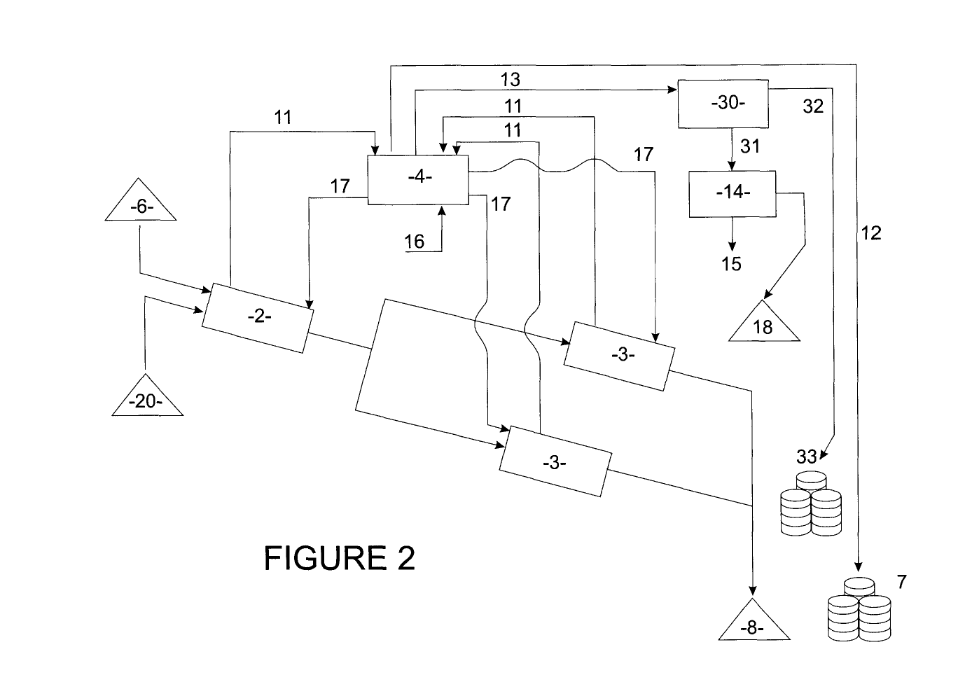

Referring to FIG. 2 a second embodiment of the waste digestion system (1) is shown. This embodiment includes a wet scrubber (30) prior to the filter (14) to reduce the load on the filter (14). The dried air (13) in this second embodiment passes through a wet scrubber (30) of known type (spray tower, plate, packed, venturi or falling film for example).

The contact fluid (the fluid used to contact the dried air (13) used in the wet scrubber (30) may be an acidic or acidified fluid but could equally be plain water depending on the contaminants present in the dried air (13). An acidic contact fluid is preferred as the remaining contaminants generally include ammonia and/or soluble ammoniacal compounds. After the dried air (13) is scrubbed it exits as treated air (31) which passes to the filter (14) for final polishing, prior to atmospheric discharge as cleaned air (15). The contact fluid, when saturated with contaminants, at a predetermined concentration of contaminants, at a predetermined time or some other criteria, exits the wet scrubber (30) as a spent scrubber fluid (32). This spent scrubber fluid (32) is used to create a second liquid product (33) stream. The second liquid product (33) stream has been found to be a useful by-product, either alone or blended with the liquid product (7) stream.

The wet scrubber (30) may include demisters or other devices intended to minimise the carryover of contact fluid into the treated air (31), these devices are well known and of a standard type if present.

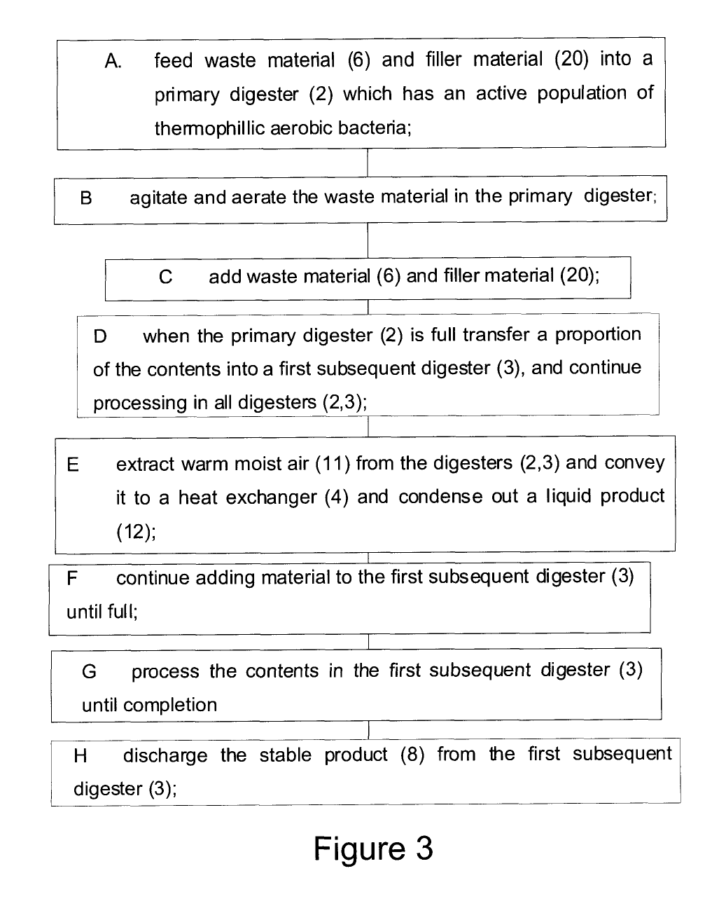

Referring to FIG. 3 a method using the waste digestion system (1) is shown in the form of a flow chart for clarity. The process includes the following steps:
A. feed waste material (6) and filler material (20) into a primary digester (2) which has an active population of thermophilic aerobic bacteria;
B. agitate and aerate the waste material in the primary digester (2);
C. add waste material (6) and filler material (20);
D. when the primary digester (2) is full transfer a proportion of the contents into a first subsequent digester (3), and continue processing in all digesters (2,3);
E. extract warm moist air (11) from the digesters (2,3) and convey it to a heat exchanger (4) and condense out a liquid product (12);
F. continue adding material to the first subsequent digester (3) until full;
G. process the contents in the first subsequent digester (3) until completion;
H. discharge the stable product (8) from the first subsequent digester (3).

In step A the primary digester (2) is already in an active state, with a stable population of one or more Thermophilic Aerobic (TA) bacteria and fresh and/or partially digested waste material (6). As digestion proceeds, more waste material (6) such as food wastes are added along with filler material (20). The filler material (20) is added to maintain the digester's (2,3) contents in a suitable physical condition, the contents need to free flowing and friable presenting sufficient surface area to the feed air (17) to maintain aerobic processing conditions. Materials such as dry sawdust, waste paper, used cardboard, or similar organic dry cellulose-rich conditioning materials are suitable as filler materials (20), as may be the spent carbon (18). If there is insufficient surface area presented to the feed air (17), the digestion slows down. Only materials that are appropriate as components in the final stable product (8) should be used as filler materials (20). These materials will of course be digested too, more or less depending on their particle size.

To get the contents of the primary digester (2) to this active state from scratch, a small quantity of material that is rich in one or more desirable TA bacteria is added to the primary digester (2) along with a substrate such as okara, moistened palm kernel extract or similar. The pH is adjusted for the selected TA bacteria, and digestion commences. As the temperature increases, more substrate is added, airflows adjusted and the digesting mass increases to the level where the digestion is more or less self-sustaining. This process commencement can be carried out in a smaller vessel, then the contents transferred to the primary digester (2) when suitably active.

In step B the primary digester (2) continues to process the waste material, with the primary digester (2) being rotated about its axis and the contents being agitated/mixed to maintain a large exposed surface area to the feed air (17).

In step C more waste material (6) and/or filler material (20) is added to maintain the contents in the free flowing and friable condition providing a sufficient surface area to the feed air (17) to maintain aerobic processing conditions. It has been found that if the helical flights are discontinuous, rather than being single helical flights running the full length of the digester, improves the performance of the digesters.

When the primary digester (2) is full step D is undertaken. In step D a proportion of the contents are transferred to an empty first subsequent digester (3). This transfer may be accomplished by any known means, but an auger and/or suction combined with reversing the direction of rotation of the primary digester (2) is one method. Transferring approximately 50% of the contents has been found to be a reasonable proportion, but it depends on the relative sizes of the digesters (2,3) and the contents condition. The transfer between the primary digester (2) and a first subsequent digester (3) may be accomplished by any suitable means that maintain the activity of the contents transferred. It should be noted that there may be more than one first subsequent digester (3) and part of the contents could be transferred to each of them. Processing now continues in both the primary digester (2) and first subsequent digester(s) (3).

Whilst the other processing steps are occurring, step E is undertaken. In step E the warm moist air (11) is extracted from the or each digester (2,3) to be processed by the heat exchanger (4). In the heat exchanger (4) the water and some or all of the condensable organic/inorganic components are condensed to form a condensate (12) and dried air (13) by cooling the warm moist air (11). A certain proportion of the dried air (13) is bled off and passed through a filter (14), in this case a carbon filter, to strip out any volatile organic compounds discharging cleaned air to atmosphere. The remaining dried air (13) is combined with fresh air (16) to form the required volume of feed air (17) for the digesters (2,3) and replenish the oxygen used by the TA bacteria. The cool feed air (17) is heated and fed back into the digesters (2,3) at the required temperature. In a preferred system the heat exchanger (4) acts as a heat recovery unit; it cools the warm moist air (11) then transfers this heat back into the cool feed air (17), minimising the need for additional heating sources. Though this heat recovery configuration is preferred additional heat can be added if the environmental conditions require this.

In step G more material from the primary digester (2) is added to the or each first subsequent digester (3) as it becomes ready, until one or more first subsequent digester (3) is at the required level. Any first subsequent digester (3) at the required level then continues to complete processing the contents of that digester (3). When the processing is complete a stable product (8) is left, this stable product (8) can be in a state that needs no further drying if desired, but the stable product (8) is essentially pathogen free friable material. During this final processing period, in the or each first subsequent digester (3), the operator maintains the conditions within that first subsequent digester (3) by adding filler material (20) or water, adjusting the pH, adjusting the feed air (17) or any other relevant process variable. The adjustments made will vary based on the operator as the waste material being processed is of a highly complex and variable nature. Given the variable nature of the waste material, and that the specific bacterial population in each digester (2,3) may be different, specific adjustments to maintain optimum processing conditions cannot be rigidly laid down, a skilled operator will make the adjustments required based on experience.

In step H the stable product (8) is discharged from the first subsequent digester (3) in which it was produced and the first subsequent digester (3) made available for further processing duties if needed.

The stable product (8) produced is suitable for use as a fertilizer.

The liquid product (7) has been found to be a liquid growth stimulant for plants and as such can also be packaged and sold as a separate product. Surprisingly the condensate (12) has recently been found to contain certain plant growth stimulants; this was unexpected as they have not been reported before. By further processing the condensate (12) it is thought that these plant growth stimulants may be able to be separated or at least concentrated.

Though not yet investigated, it is possible that additional plant growth stimulants or other valuable by-products could be extracted or captured by the filter (14), or wet scrubber (30) if present. If this is the case then the saturated filter material, and/or spent scrubber fluid (32) where present, could be processed to extract these.

The process described takes between 24 hours and 48 hours to process the waste material (6) into a usable solid product (8) and if correctly run the product discharged from the first subsequent digester(s) (3) needs no further drying before packaging.

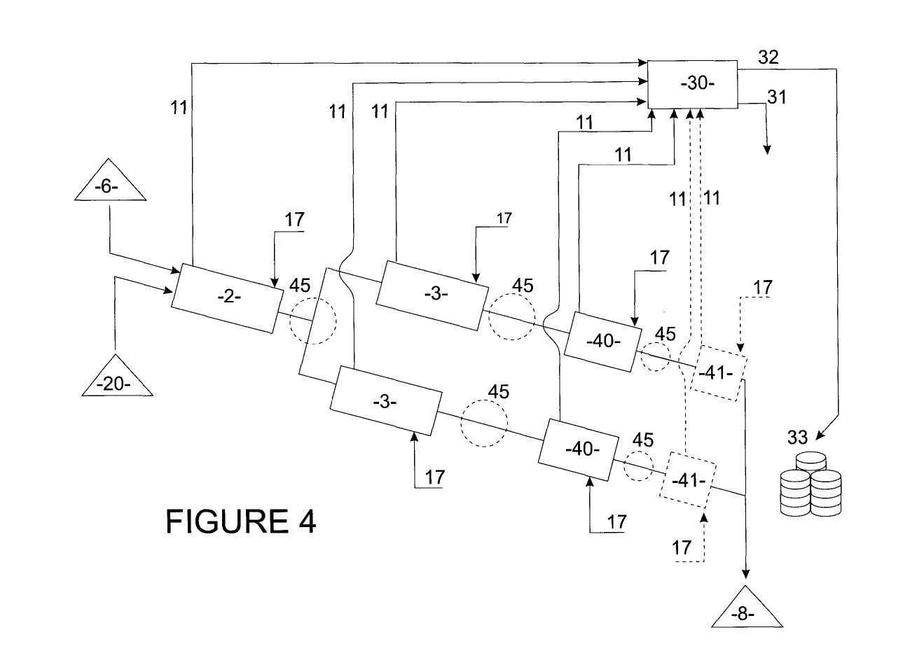

Referring to FIG. 4 a third preferred embodiment of the invention is shown, in this embodiment each first subsequent digester (3) is followed by a second subsequent digester (40). Optionally these second subsequent digesters (40) may in turn be followed by further subsequent digesters (41).

This forms a series of parallel chains of subsequent reactors (3,40,41) which improves the processing options.

Each digester (2,3,40,41), not shown in detail, is a cylindrical or conically shaped drum which is rotatable along a central axis. In a preferred form each digester (2,3.40,41) includes one or more longitudinally aligned helical flights attached to the inside surface of the drum configured to agitate and aerate the contents of said drum when in use. These helical flights may extend part way along, or along the entire, length of the drum and be continuous or discontinuous depending on the material concerned. During operation a slight negative pressure can be maintained in the digesters (2,3,40,41) to minimise or eliminate the release of malodorous or harmful gaseous discharges. Each of the digesters (2,3,40,41), when in use, is rotated around its central axis by a known means such as, but not limited to, belt drive system, chain drive system, jockey wheel, direct drive, indirect drive or combination of these.

The heat loss from the digesters (2,3,40,41), during processing, is sufficiently low so as to prevent much, if not all, of the moisture present inside said digesters (2,3) from condensing on the inside walls. To minimise the heat loss from the digesters (2,3,40,41) may be double skinned or otherwise insulated (by any known means).

In this embodiment the moist warm air (11) produced in each of the digesters (2,3,40,41) is fed directly into a wet scrubber (30) where it is contacted with a contact fluid to strip out some or all of the ammonia, amine, ammoniacal/nitrogen compounds and other contaminants from the warm moist air (11). Preferably the contact fluid is acidic to improve the extraction efficiency. The wet scrubber (30) can be of any known single or multistage type (spray tower, plate, packed, venturi or falling film for example). The wet scrubber (30) may allow the warm moist air (17) or the contact fluid to recycle through a number of times to improve extraction of these materials. The spent scrubber fluid (32) passes out of the wet scrubber (30) and is packaged, or further processed then packaged as the second liquid product stream (33). The warm moist air (11) exits the wet scrubber as cleaned air (31) which as it is warm saturated air, often with an increased Carbon Dioxide loading, could be used as an air feed for glass houses, be cooled to extract heat or additional by products or other purposes.

Though an acidic contact fluid is preferred it could equally be water, acidic, alkaline, solvent based or a complex contact fluid designed to optimise the extraction of useful by-products.

In this third embodiment a size reduction device (45) may be present between adjacent connected digesters (2,3,40,41) to break down larger material from the previous digester (2,3,40,41) to maintain an optimum exposed surface area. This optimum size is material and processing stage dependent and it is difficult to precisely define.

The final subsequent digester (3,40,41) completes the processing and when complete discharges a dry friable material able to be packaged directly as the stable product (8), or combined with other materials to form the stable product (8).

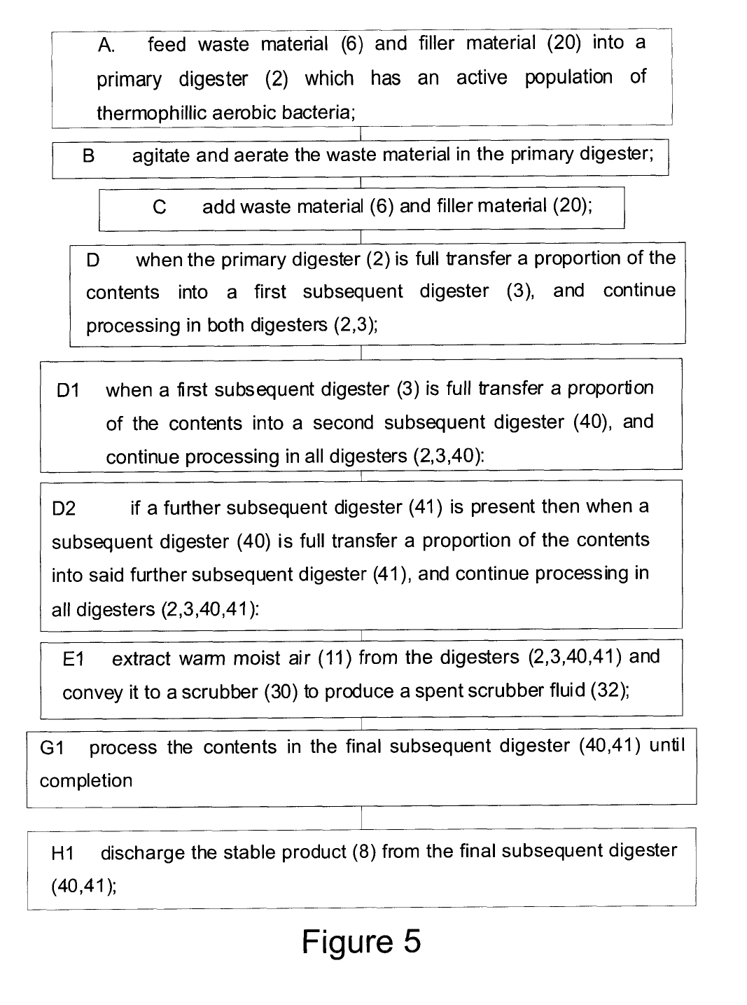

Referring to FIG. 5 a method of using the third embodiment of the waste digestion system (1) is shown in the form of a flow chart for clarity. The method includes the following steps:
A. feed waste material (6) and filler material (20) into a primary digester (2) which has an active population of thermophilic aerobic bacteria;
B. agitate and aerate the waste material in the primary digester (2);
C. add waste material (6) and filler material (20);
D. when the primary digester (2) is full transfer a proportion of the contents into a first subsequent digester (3), and continue processing in both digesters (2,3);
D1. when the first subsequent digester (3) is full transfer a proportion of the contents into a second subsequent digester (40), and continue processing in all digesters (2,3,40);
D2. if a further subsequent digester (41) is present then when the second subsequent digester (40) is full transfer a proportion to a further subsequent digester (41), and continue processing in all digesters (2,3,40,41);
E1. extract warm moist air (11) from the digesters (2,3,40,41) and convey it to a wet scrubber (30) to produce a spent scrubber fluid (32);
G1. process the contents in the final subsequent digester (40,41) until completion;
H1. discharge the stable product (8) from the final subsequent digester (40,41).

In step A the primary digester (2) is already in an active state, with a stable population of one or more Thermophilic Aerobic (TA) bacteria and fresh and/or partially digested waste material (6). As digestion proceeds, more waste material (6) such as food wastes are added along with filler material (20). The filler material (20) is added to maintain the digester's (2,3) contents in a suitable physical condition, the contents need to free flowing and friable presenting sufficient surface area to the feed air (17) to maintain aerobic processing conditions. Materials such as dry sawdust, waste paper, used cardboard, or similar organic dry cellulose-rich conditioning materials are suitable as filler materials (20), as may be the spent carbon (18). If there is insufficient surface area presented to the feed air (17), the digestion slows down. Only materials that are appropriate as components in the final stable product (8) should be used as filler materials (20). These materials will of course be digested too, more or less depending on their particle size.

To get the contents of the primary digester (2) to this active state from scratch, a small quantity of material that is rich in one or more desirable TA bacteria is added to the primary digester (2) along with a substrate such as okara, moistened palm kernel extract or similar. The pH is adjusted for the selected TA bacteria, and digestion commences. As the temperature increases, more substrate is added, airflows adjusted and the digesting mass increases to the level where the digestion is more or less self-sustaining. This process commencement can be carried out in a smaller vessel, then the contents transferred to the primary digester (2) when suitably active.

In step B the primary digester (2) continues to process the waste material, with the primary digester (2) being rotated about its axis and the contents being agitated/mixed to maintain a large exposed surface area to the feed air (17).

In step C more waste material (6) and/or filler material (20) is added to maintain the contents in the free flowing and friable condition providing a sufficient surface area to the feed air (17) to maintain aerobic processing conditions. It has been found that if the helical flights are discontinuous, rather than being single helical flights running the full length of the digester, improves the performance of the digesters.

When the primary digester (2) is full step D is undertaken. In step D a proportion of the contents are transferred to an empty first subsequent digester (3). This transfer may be accomplished by any known means, but an auger and/or suction combined with reversing the direction of rotation of the primary digester (2) is one method. Transferring approximately 50% of the contents has been found to be a reasonable proportion, but it depends on the relative sizes of the digesters (2,3) and the contents condition. The transfer between the primary digester (2) and a first subsequent digester (3) may be accomplished by any suitable means that maintain the activity of the contents transferred. It should be noted that there may be more than one first subsequent digester (3) and part of the contents could be transferred to each of them. Processing now continues in both the primary digester (2) and first subsequent digester(s) (3).

When the first subsequent digester is full step D1 is undertaken. In step D1 a proportion of the contents of the first subsequent digester (3) are transferred to an empty second subsequent digester (40). This transfer may be accomplished by any known means, but an auger and/or suction combined with reversing the direction of rotation of the first subsequent digester (3) is one method. Transferring approximately 50% of the contents has been found to be a reasonable proportion, but it depends on the relative sizes of the digesters (3,40) and the contents condition. The transfer between the first subsequent digester (2) and a second subsequent digester (40) may be accomplished by any suitable means that maintain the activity of the contents transferred. Processing now continues in all of the digesters (2,3,40).

When a further subsequent digester (41) is present, and the second subsequent digester (40) is full then the optional step D2 is actioned. In step D2 a proportion of the contents of the second subsequent digester (41) are transferred to an empty further subsequent digester (41). This transfer may be accomplished by any known means, but an auger and/or suction combined with reversing the direction of rotation of the second subsequent digester (40) is one method. Transferring approximately 50% of the contents has been found to be a reasonable proportion, but it depends on the relative sizes of the digesters (40,41) and the contents condition. The transfer between the second subsequent digester (2) and a further subsequent digester (41) may be accomplished by any suitable means that maintain the activity of the contents transferred. Processing now continues in all of the digesters (2,3,40,41).

Whilst the other processing steps are occurring, step E1 is undertaken. In step E1 the warm moist air (11) is extracted from each digester (2,3,40,41) to be processed by the wet scrubber (30). In the wet scrubber (30) the extracted warm moist air (11) is contacted with an acidic contact fluid which neutralises and extracts a variety of contaminants from the warm moist air (11). The most common contaminants in the warm moist air (11) are ammonia, ammoniacal compounds and amines which convert to soluble salts as part of the scrubbing process. The warm moist air (11) and/or wet scrubber (30) acidified contact fluid may be circulated around the wet scrubber (30) a number of times to improve the separation. It should be noted that the term wet scrubber (30) is intended to cover any gas liquid contact device intended to strip compounds from the gas stream into the liquid stream. The contact fluid, when saturated with contaminants, at a predetermined concentration of contaminants, at a predetermined time or some other criteria, exits the wet scrubber (30) as a spent scrubber fluid (32). This spent scrubber fluid (32) is used to create the second liquid product (33) stream. The treated air (31) exits the wet scrubber (30) and may be used for a variety of purposes. It should be noted that this step though preferred as it yields a further valuable product it is optional.

In step G1 more material from the digesters (2,3,40), except the final subsequent digester (40,41), is added to the following subsequent digester (3,40,41) as it becomes ready, until one or more final subsequent digester (40,41) is at the required level. Any final subsequent digester (40,41) at the required level then continues to complete processing the contents of that final subsequent digester (40,41). When the processing is complete a stable product (8) is left, this stable product (8) needs no further drying if the first subsequent digester (3) has been operated correctly. During this final processing period, in the or each first subsequent digester (3), the operator maintains the conditions within that first subsequent digester (3) by adding filler material (20) or water, adjusting the pH, adjusting the feed air (17) or any other relevant process variable. The adjustments made will vary based on the operator as the waste material being processed is of a highly complex and variable nature. Given the variable nature of the waste material, and that the specific bacterial population in each digester (2,3) may be different, specific adjustments to maintain optimum processing conditions cannot be rigidly laid down, a skilled operator will make the adjustments required based on experience.

In step H the stable product (8) is discharged from the final subsequent digester (40,41) in which it was produced and the final subsequent digester (40,41) made available for further processing duties if needed.

The process described takes between 24 hours and 48 hours to process the waste material (6) into a usable stable product (8). If correctly run the final subsequent digester(s) (3,40,41) can produce a stable product (8) which needs no further drying before packaging.

It should be noted that bones and shells, where present, and similar effectively mineral materials, may be separated out during the process for size reduction then added back to a digester (2,3,40,41).

A further embodiment can simply vent the volatile organic compounds for flaring or direct discharge into the atmosphere.

A further embodiment allows the addition of heat or minimal heat recovery if required.

A still further embodiment uses the combustion of the volatile organic compounds to provide additional heat if required.

In a further embodiment all of the dry air (13) is discharged through the filter (14) and in this case the feed air (17) is made up entirely of heated fresh air (16). This may be required where the oxygen demand of the digesters (2,3) or volatile organic loading of the moist warm air (11) requires it; though it may simply be desirable for other reasons.

In a further embodiment the heat exchanger (4) may in fact be two physically separated heat exchangers, one that condenses the condensate (12) and one that heats the cool feed air (17).

In a preferred form each digester (2,3) has a shape similar to that of a concrete mixer bowl, as used on concrete trucks, of about 7 cubic metre capacity. The length of the digester (2,3) is limited by the need to maintain the proper mixing and aeration of the entire contents of the digester (2,3).

In one embodiment the thermophilic aerobic bacteria used is that naturally occurring in the feed material.

In an alternative embodiment the thermophilic aerobic bacteria is one or more strains of bacillus subtilis or similar higher temperature naturally occurring bacteria.

Where the terms waste material (6) or filler material (20) are used, these are intended to cover any substrate added to produce the starter, or maintain the digestion in the desired state.

Where the term drawn is used in relation to ‘air drawn through a digester’ this is meant to indicate that the air is not pressurised to pass through the waste material.

So the present waste digestion system includes at least two stages of digestion, with only a proportion of the contents transferred between stages, this maintains the activity in each of the stages without reseeding with bacteria. There is a single first stage which can feed one or more parallel chains of subsequent stages. This means that the breakdown of waste organic material commences immediately when introduced into the first digester once the system is running, this eliminates the need for external heating.

1. A waste digestion system including a primary digester and one or more first subsequent digesters for processing non-liquid organic waste material without the addition of external heat using thermophilic aerobic bacteria to produce a stable product, said digesters being configured to contain contents including the waste material, each of said digesters further including mixing means configured to mix the contents of that digester with feed air drawn through contents during processing in such a way as to maintain essentially aerobic conditions within the digester; such that the waste material is first processed in the primary digester before a proportion of the contents of the primary digester is transferred to at least one first subsequent digester where further processing occurs; if the first subsequent digester completes the processing then it is a final subsequent digester, such that the contents in the or each of the subsequent digesters are friable.

2. The waste digestion system as claimed in claim 1 characterised in that following the or each first subsequent digester there is a second subsequent digester configured to further process the contents transferred from an upstream first subsequent digester, where a second subsequent digester completes the processing then it is a final subsequent digester, such that the contents in the or each of the subsequent digesters are friable.

3. The waste digestion system as claimed in claim 2 characterised in that following the or each second subsequent digester there is one or more serially connected further subsequent digester configured to further process the contents transferred from an upstream subsequent digester, where a further subsequent digester completes the processing then it is a final subsequent digester, such that the contents in the or each of the subsequent digesters are friable.

4. (canceled)

5. The waste digestion system as claimed in claim 1 characterised in that each final subsequent digester is configured to produce a dry product without any additional drying necessary.

6. The waste digestion system as claimed in claim 1 characterised in that the processing occurs between 60° C. and 70° C.

7. The waste digestion system as claimed in claim 1 characterised in that there is a size reduction means between one or more immediately adjacent digesters.

8. The waste digestion system as claimed in claim 7 characterised in that each size reduction means can be independently controlled.

9. The waste digestion system as claimed in claim 1 characterised in that the waste material is high in protein.

10. The waste digestion system as claimed in claim 1 characterised in that the thermophilic aerobic bacteria is/are naturally part of the organic waste material.

11. The waste digestion system as claimed in claim 1 characterised in that the thermophilic aerobic bacteria is/are added.

12. The waste digestion system as claimed in claim 1 characterised in that the thermophilic aerobic bacteria is/are one or more strains of bacillus subtilis or a similar higher temperature naturally occurring bacteria.

13. The waste digestion system as claimed in claim 1 characterised in that each digester is essentially cylindrical, conical or a combination of these shapes with the mixing means including at least one strip attached to an inner surface of said digester, such that the plane of the or each said strip lies perpendicular to the inner surface to which it is attached, and wherein the or each strip follows a continuous or discontinuous helical or curved path along at least part of the length of the inner surface.

14. The waste digestion system as claimed in claim 1 characterised in that the waste digestion system includes a wet scrubber configured to contact an air stream drawn from one or more of the digesters with a contact fluid to form a spent scrubber fluid.

15. The waste digestion system as claimed in claim 14 characterised in that the contact fluid is selected from the following list: an acidified contact fluid, an alkaline contact fluid, a solvent based contact fluid, a non solvent based contact fluid, a formulated contact fluid and a combined contact fluid, where the formulated contact fluid is configured to extract, dissolve and/or neutralise nitrogen and sulphur compounds from the air drawn from the digesters.

16. The waste digestion system as claimed in claim 14 characterised in that the spent scrubber fluid is a nitrogen rich fluid.

17. The waste digestion system as claimed in claim 14 characterised in that the spent scrubber fluid is essentially neutral.

18. The waste digestion system as claimed in claim 1 characterised in that the waste digestion system includes a heat exchanger configured to essentially dry a warm moist air stream extracted from one or more of the digesters creating a dried air stream and a condensate.

19. The waste digestion system as claimed in claim 18 characterised in that the heat exchanger is configured to separate of a proportion of the dried air and mix it with fresh air to create the cool feed air.

20. The waste digestion system as claimed in claim 18 characterised in that the heat exchanger is configured to recover the heat from the warm moist air stream drawn from and use it to heat the cool feed air prior to returning it to each digester.

21. The waste digestion system as claimed in claim 18 characterised in that the condensate is a product of the system.

22. The waste digestion system as claimed in claim 18 characterised in that the condensate is further processed to separate out, or form a concentrate rich in, plant growth stimulants.

23. A method of using the waste digestion system as claimed in claim 1 that includes the following steps:
A. feed waste material and filler material into a primary digester which has an active population of thermophilic aerobic bacteria;
B. agitate and aerate the waste material in the primary digester;
C. add waste material and filler material;
D. when the primary digester is full transfer a proportion of the contents into a first subsequent digester, and continue processing in all digesters;
E. extract warm moist air from the digesters and convey it to a heat exchanger and condense out a liquid product;
F. continue adding material to the first subsequent digester until full;
G. process the contents in the first subsequent digester until completion;
H. discharge the stable product from the first subsequent digester.

24. A method of using the waste digestion system as claimed in claim 2 that includes the following steps:
A. feed waste material and filler material into a primary digester which has an active population of thermophilic aerobic bacteria;
B. agitate and aerate the waste material in the primary digester;
C. add waste material and filler material;
D. when the primary digester is full transfer a proportion of the contents into a first subsequent digester, and continue processing in both digesters;
D1. when the first subsequent digester is full transfer a proportion of the contents into a second subsequent digester, and continue processing in all digesters;
D2. if a further subsequent digester is present then when the second subsequent digester is full transfer a proportion to a further subsequent digester, and continue processing in all digesters;
G1. process the contents in the final subsequent digester until completion;
H1. discharge the stable product from the final subsequent digester.

25. The method of using the waste digestion system as claimed in claim 24 characterised in that at the same time as any one of steps A to H1 are undertaken step E1 is undertaken,
E1. extract warm moist air from the digesters and convey it to a wet scrubber to produce a spent scrubber fluid.

26. The method as claimed in claim 23 characterised in that the stable product is a dry friable material.

27. The method as claimed in claim 23 characterised in that the waste material is processed to the stable product in less than 48 hours.

28. The method as claimed in claim 23 characterised in that the waste material is processed to the stable product in between 24 and 48 hours.

29. The waste digestion system as claimed in claim 2 characterised in that each final subsequent digester is configured to produce a dry product without any additional drying necessary.

30. The waste digestion system as claimed in claim 3 characterised in that each final subsequent digester is configured to produce a dry product without any additional drying necessary.

31. The method as claimed in claim 24 characterised in that the stable product is a dry friable material.

32. The method as claimed in claim 25 characterised in that the stable product is a dry friable material.
